(19) United States
(12) Patent Application Publication
(10) Pub. No.: US 2016/0138327 A1
(43) Pub. Date: May 19, 2016

(54) DRAIN COVER ASSEMBLY

(71) Applicant: Sunview Patio Doors Ltd., Woodbridge (CA)

(72) Inventors: Tony Margiotta, Maple (CA); Kurt Oberparleiter, Uxbridge (CA)

(73) Assignee: SUNVIEW PATIO DOORS LTD., Woodbridge (CA)

(21) Appl. No.: 14/541,486

(22) Filed: Nov. 14, 2014

(51) Int. Cl. E06B 7/14; E06B 1/70; E06B 7/16

(52) U.S. Cl. CPC E06B 7/14; E06B 7/16; E06B 1/70

(57) ABSTRACT

A drain cover assembly for covering an aperture in an exterior portion of a frame of an architectural element system including a drain in fluid communication with the aperture. The drain cover assembly includes a body formed to cover the aperture and a perimeter area of the exterior portion located around the aperture, and an attachment element for attaching an attachment portion of the body to one or more first portions of the perimeter area. The perimeter area additionally includes one or more second portions that are unattached to the attachment portion of the body.

### FIELD OF THE INVENTION

The present invention is a drain cover assembly for covering an aperture of a drain in a frame of an architectural element system.

### BACKGROUND OF THE INVENTION

In the prior art, certain architectural elements, such as patio doors, typically include a frame that has a number of components, including a sill. The prior art frame typically includes one or more relatively small drains that are formed in the frame to permit water to exit from the drain at an opening in the frame, under the influence of gravity. For example, in a typical patio door, the drain may be approximately 1 inch (approximately 25.4 mm) wide and approximately 0.15 inches (approximately 3.8 mm) in height.

The opening typically is in the sill. The opening is usually coverable by a small, rigid, weep cover that is pivotable, on hinges. The weep cover may be, for example, approximately 2 inches (approximately 50.8 mm) wide and approximately 0.31 inch (approximately 7.9 mm) in height. The weep cover typically is designed to swing freely on its hinges, i.e., the weep cover is not biased to any position, and is intended to be positioned by gravity.

As is well known in the art, water that accumulates in grooves in the door frame is directed to the drain. It is intended that the weep cover that covers the opening will remain closed until water that has accumulated in the drain pushes the weep cover open, thereby allowing the water to exit the drain via the opening.

The weep cover may be formed of a variety of materials, in various ways. The weep cover typically is an inflexible flap. Typically, the weep cover is made of polyvinylchloride (PVC), by injection molding.

There are problems with the typical arrangement. The weep cover be mounted in a small housing that is installed in the drain opening. However, in practice, the weep cover frequently does not function properly. For instance, because it is rigid and the hinges may not function properly, the weep cover may temporarily be fixed in an open or in a closed position. Also, the weep cover may not fit well over the opening when the weep cover is closed, so that cold (or hot) air from the atmosphere, and rain or snow, may penetrate into the drain to an extent, even when the weep cover is closed. Because of the weep cover's failure to close properly, or to remain closed, the architectural element may not achieve the overall insulative performance intended.

### SUMMARY OF THE INVENTION

There is a need for a drain cover assembly that overcomes or mitigates one or more of the disadvantages or defects of the prior art. Such disadvantages or defects are not necessarily included in those listed above.

In its broad aspect, the invention provides a drain cover assembly for covering an aperture in an exterior portion of a frame of an architectural element system including a drain in fluid communication with the aperture. The drain cover assembly includes a body formed to cover the aperture and a perimeter area of the exterior portion located around the aperture, and an attachment element for attaching an attachment portion of the body to one or more first portions of the perimeter area. The perimeter area additionally includes one or more second portions that are unattached to the attachment portion of the body.

In another of its aspects, the invention provides a method of controlling a flow of one or more fluids in a drain located in a frame of an architectural element system at least partially defined by an exterior portion of the frame having an aperture in fluid communication with the drain. The method includes providing a body formed to cover the aperture and a perimeter area of the exterior portion surrounding the aperture. Next, with an attachment element, an attachment portion of the body is attached to one or more first portions of the perimeter area. An unattached portion of the body is permitted to move between a closed position, in which an engagement region of the unattached portion of the body is substantially engaged with at least part of one or more second portions of the perimeter area that are unattached to the attachment portion, and an open position, in which the unattached portion of the body is at least partially disengaged from the second portion of the perimeter area.

In another of its aspects, the invention provides an architectural element system for installation in a structure. The architectural element system includes a frame having an exterior portion thereof and a drain therein in fluid communication with an aperture located in the exterior portion, a body formed to cover the aperture and a perimeter area of the exterior portion located around the aperture, and an attachment element for attaching an attachment portion of the body to one or more first portions of the perimeter area. Also, the perimeter area additionally includes one or more second portions that are unattached to the attachment portion of the body.

### BRIEF DESCRIPTION OF THE DRAWINGS

The invention may be better understood with reference to the attached drawings, in which:

FIG. 1 is a front view of an embodiment of an architectural element system of the invention, installed in a structure;

FIG. 2A is a front view of an embodiment of a drain cover assembly of the invention, drawn at a larger scale;

FIG. 2B is a front view of a portion of a frame of the architectural element system of FIG. 1 with an outline of an embodiment of a body of the invention outlined to show the position of the body vis-à-vis an aperture in the frame;

FIG. 3A is a cross-section of the portion of the frame of the architectural element system of FIGS. 2A and 2B taken along line 3-3 in FIG. 2A showing an unattached portion of the body of the drain cover assembly of FIG. 2A in a closed position, drawn at a smaller scale;

FIG. 3B is a cross-section of the portion of the frame and the body of FIG. 3A taken along line 3-3 in FIG. 2A in which the unattached portion is shown in an open position; and

FIG. 4 is a graph comparing the extent of air leakage when various weepers of the prior art are used, and when an embodiment of the drain cover assembly of the invention is used.

### DETAILED DESCRIPTION

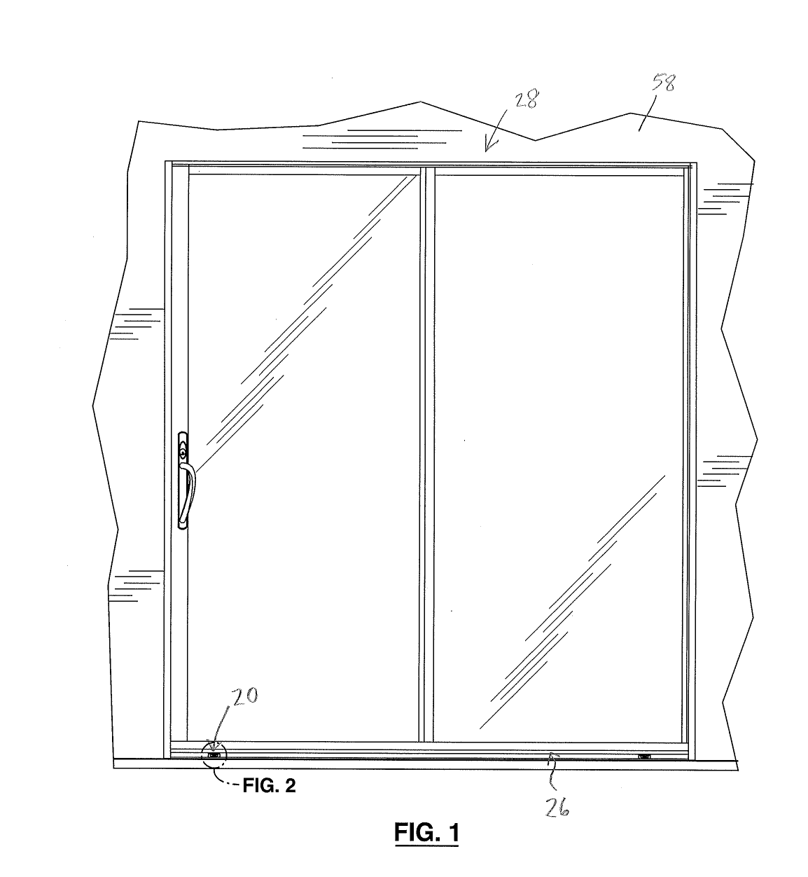

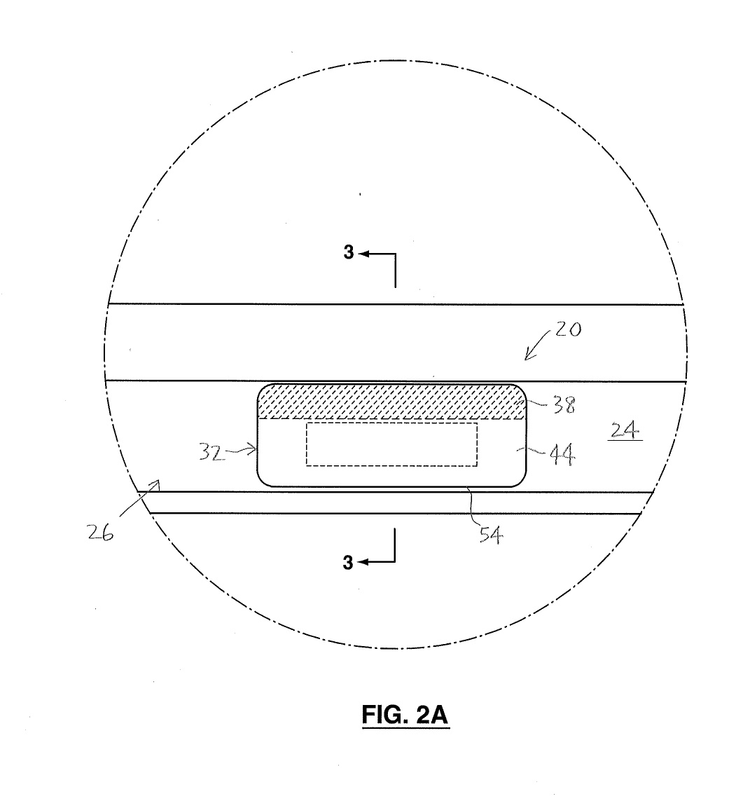

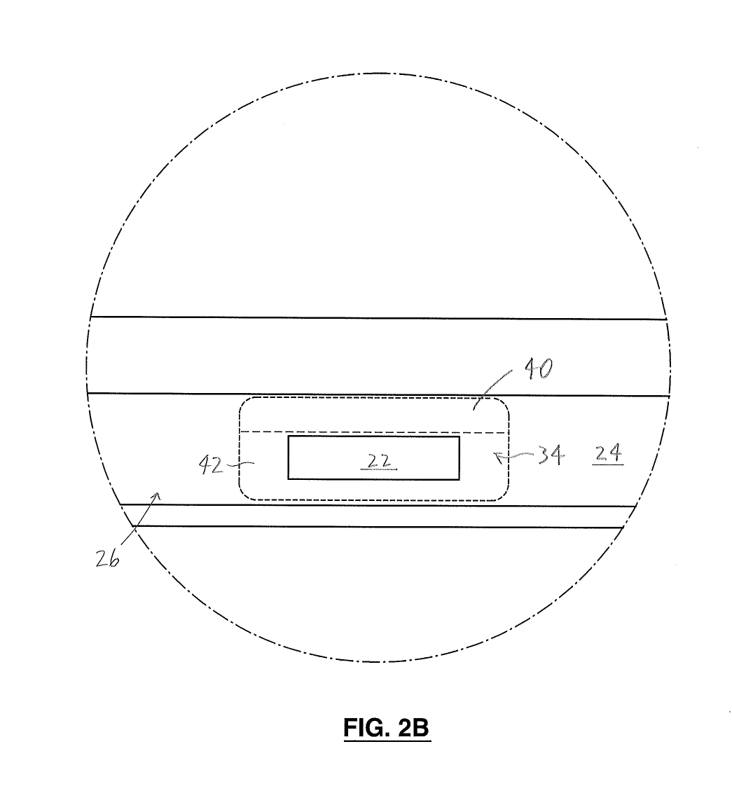

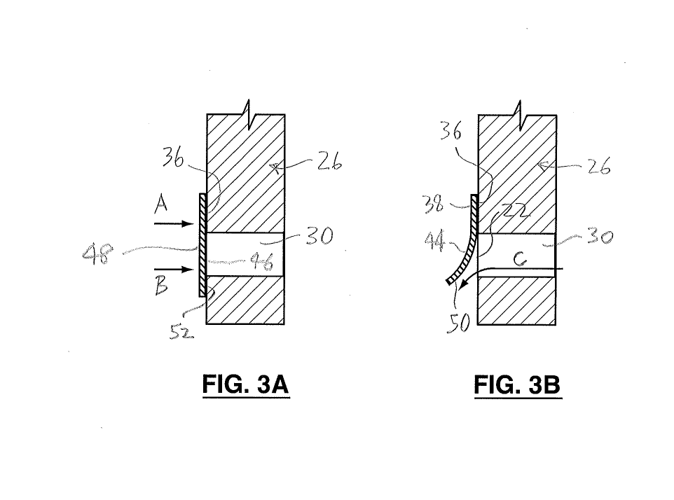

In the attached drawings, like reference numerals designate corresponding elements throughout. Reference is made to FIGS. 1-3B to describe an embodiment of a drain cover assembly in accordance with the invention indicated generally by the numeral 20 (FIGS. 1, 2A, 3A, 3B). As can be seen in FIGS. 1-3B, the drain cover assembly 20 is for covering an aperture 22 in an exterior portion 24 of a frame 26 of an architectural element system 28 (FIG. 1) that includes a drain 30 (FIGS. 3A, 3B) in fluid communication with the aperture 22. In one embodiment, the drain cover assembly 20 preferably includes a body 32 formed to cover the aperture 22 and a perimeter area 34 of the exterior portion 24 located around the aperture 22, as will be described. It is also preferred that the drain cover assembly 20 includes an attachment element 36 for attaching an attachment portion 38 of the body 32 to one or more first portions 40 of the perimeter area 34 (FIG. 2B). Preferably, the perimeter area 34 additionally includes one or more second portions 42 that are unattached to the attachment portion 38 of the body 32.

As can be seen in FIG. 2A, in one embodiment, the first portion 40 of the perimeter area 34 to which the attachment portion 28 of the body is attached is at least partially located above the aperture 22.

It is also preferred that the body 32 includes an unattached portion 44 thereof that is engageable with the second portion 42 of the perimeter area 34 when the attached portion 38 of the body 32 is attached to the first portion 40 of the perimeter area 34.

The body 32 preferably is made of any suitable material. It is preferred that the body 32 is flexible, and those skilled in the art would appreciate that the body 32 preferably is made of a material (or materials) that is flexible over a relatively wide temperature range and preferably generally resists degradation. For instance, in one embodiment, the body 32 preferably is made of neoprene (or polychloroprene).

In one embodiment, the body 32 preferably is relatively small, e.g., approximately 1.57 inches (40 mm) in width and approximately 0.60 inches (15 mm) in height. (It will be understood that the aperture is substantially smaller than the body 32, so that the body 32 preferably covers the aperture 22 and the entire perimeter area 34.) Preferably, the body 32 is relatively thin. For example, if the body 32 is made of neoprene, it may be approximately 0.025 inches (approximately 0.6 mm) thick. It is also preferred that the attachment element 36 is any suitable means for attaching the attachment portion 38 of the body 32 to the first portion 40.

In one embodiment, the body 32 preferably includes an inner side 46 thereof and an opposed outer side 48 (FIG. 3A). In the attachment portion 38, the inner side 46 is attachable to at least part of the first portion 40 of the perimeter area, as can be seen in FIGS. 2A, 3A, and 3B. Also, in the unattached portion 44, the inner side 46 is engageable with the second portion 42 of the perimeter area 34 when the attached portion 38 is attached to the first portion 40.

It is also preferred that the unattached portion 44 is movable relative to the frame 26 between a closed position (FIG. 3A), in which an inner engagement region 50 of the inner side 46 in the unattached portion 44 is engaged with at least part of the second portion 42 of the perimeter area 34, and an open position (FIG. 3B), in which the inner engagement region 50 is at least partially unengaged with the second portion 42 of the perimeter area 34.

As noted above, and as can be seen in FIGS. 2A, 2B, and 3A, when the unattached portion 44 is in the closed position, the body 32 covers the aperture 22 and the perimeter area 34.

Preferably, the attachment element 36 is any suitable means for attaching the attached portion 38 of the body 32 to the first portion 40 of the perimeter area 34. For instance, in one embodiment, the attachment element 36 preferably is any suitable adhesive that is positioned on the inner side 46 in the attached portion 38. Those skilled in the art would be aware of various suitable adhesives. Preferably, the adhesive is positioned on the inner side in the attached portion when the body is manufactured.

For instance, it has been found that a low surface energy adhesive transfer tape is suitable for use with the neoprene body 32 described above. Such tape preferably includes a sticky film on an interior side thereof that secures the tape to the inner side of the body, in the attached portion 38.

In one embodiment, it is also preferred that the adhesive 36 is positioned on the inner side 46 in the attached portion 38 with a small piece of suitable release liner (not shown) located on the adhesive 36. The release liner preferably remains in position on the adhesive 36 until shortly before the attached portion 38 of the body 32 is to be attached to the first portion 40 of the perimeter area 34. In order to attach the attached portion 38 to the first portion 40 of the perimeter area 34, the release liner is pulled off the adhesive 36 and the adhesive 36 is engaged with the first portion 40.

As described, the attached portion 38 preferably (although not necessarily) includes a relatively small proportion of the surface area of the inner side. If a relatively taller body can be used, then the unattached portion may be sufficiently flexible even if a relatively smaller proportion of the inner area of the body may be attached to the first portion of the perimeter area. Similarly, less of the inner side may be attached to the first portion of the perimeter area if the body is softer (i.e., has a relatively lower durometer).

For instance, the inner side in the attached portion may represent approximately one-third (33.3%) of the total inner side of the body 32. Accordingly, the unattached portion 44 preferably includes a correspondingly larger proportion of the area of the inner side. As noted above, it is also preferred that the body 32 is made of flexible material. The unattached portion 44 accordingly preferably is formed so that, when the attached portion 38 is attached to the first portion 40, the unattached portion 44 is bendable, while the attached portion 38 remains secured to the frame 26.

Preferably, the unattached portion 44 of the body 32 is movable relative to the frame 26 between the closed position, in which an engagement region 52 of the unattached portion 44 is engaged with at least part of the second portion 42 of the perimeter area 34, and the open position, in which the unattached portion 44 of the body 32 is at least partially disengaged with the second portion 42 of the perimeter area 34.

It is also preferred that the unattached portion 44 of the body 32 is biased to the closed position. Those skilled in the art would appreciate that the biasing may be effected using various means. In one embodiment, the unattached portion 44 preferably is biased to the closed position by the elasticity of the material that forms the body. For instance, it has been found that, when the body is made of neoprene, the properties of that material are such that, when a bottom end 54 of the unattached portion 44 is moved outwardly from the second portion 42 of the perimeter area 34 (e.g., under pressure from water in the drain), the bottom end 54 of the unattached portion 44 has a tendency to return to engagement with the second portion 42.

For instance, in one embodiment, the unattached portion 44 of the body 32 is bendable away from the exterior portion 24 of the frame 26 in response to pressure exerted on the unattached portion 44 by at least one fluid (not shown) located in the drain 30, to at least partially disengage the unattached portion 44 from the second portion 42 of the perimeter area 34, allowing the fluid to flow out of the drain, under the influence of gravity.

In use, the invention provides a method of controlling a flow of fluid in the drain 30. The method includes providing the body 32 formed to cover the aperture 22 and also to cover the perimeter area 34 of the exterior portion 24 surrounding the aperture 22. With an attachment element 36, the attached portion 38 of the body 32 is attached to the first portion 40 of the perimeter area 34. The unattached portion 44 of the body 32 is permitted to move between the closed position, in which the engagement region of the unattached portion of the body is substantially engaged with at least part of the second portion of the perimeter area that is unattached to the attachment portion, and the open position, in which the unattached portion of the body is at least partially disengaged from the second portion of the perimeter area.

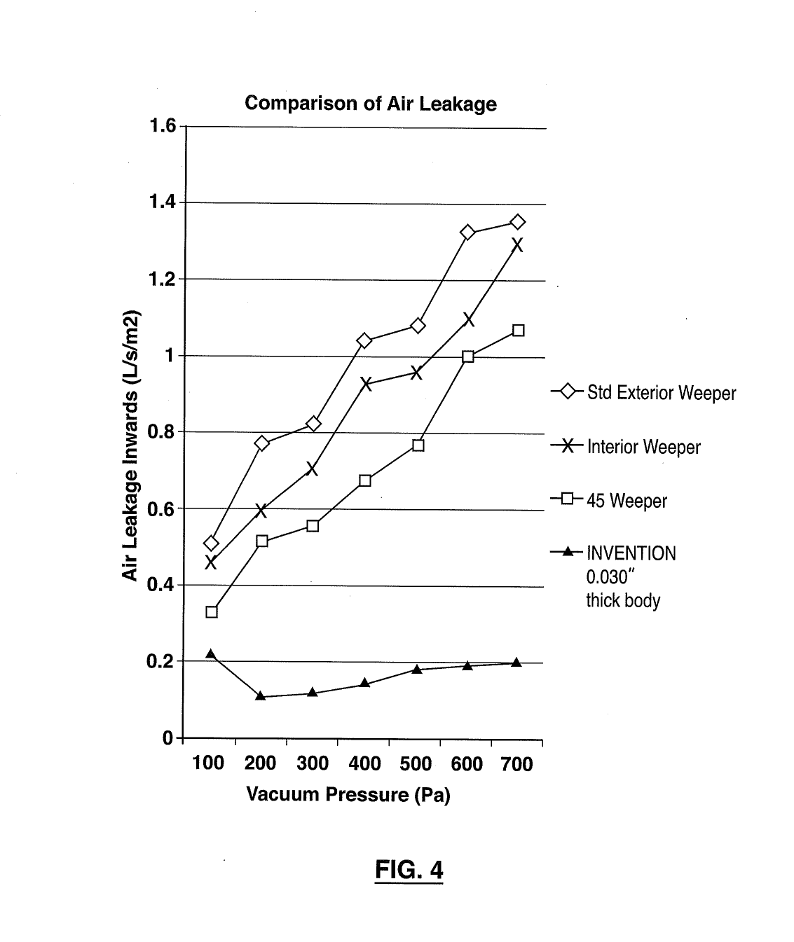

It has been found that the drain cover assembly 20 of the invention provides a relatively leak-free seal around the aperture 22. This is shown in FIG. 4, in which the extent of leakage into an interior space of the structure is shown to be greater when prior art devices are used. For instance, atmospheric winds directed against the body 32 (e.g., in the direction indicated by arrows “A” and “B” in FIG. 3A) are unlikely to get past the body 32 and into the drain 30, partly due to the width of the second portion 42 of the perimeter area 34, and partly due to the biasing of the unattached portion 44 of the body 32 to the closed position. As can be seen in FIG. 3B, the water (not shown) that has accumulated in the drain 30 exits, as indicated by arrow “C”, when the unattached portion 44 is moved to the open position by pressure exerted by the water (FIG. 3B).

In another embodiment, the invention preferably includes the architectural element system 28 for installation in a structure 58. The architectural element system 28 preferably includes the frame 26 with the exterior portion 24 thereof and the drain 30 therein in fluid communication with the aperture 22 located in the exterior portion 24. The architectural element system 28 preferably also includes the drain cover assembly 20, described above. As noted above, the architectural element system 20 may be, for example, a set of patio doors, a window, a door, or any other similar architectural element system.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A drain cover assembly for covering an aperture in an exterior portion of a frame of an architectural element system comprising a drain in fluid communication with the aperture, the drain cover assembly comprising:
a body formed to cover the aperture and a perimeter area of the exterior portion located around the aperture;
an attachment element for attaching an attachment portion of the body to at least one first portion of the perimeter area; and
the perimeter area additionally comprising at least one second portion that is unattached to the attachment portion of the body.

2. A drain cover assembly according to claim 1 in which said at least one first portion of the perimeter area to which the attachment portion of the body is attached is at least partially located above the aperture.

3. A drain cover assembly according to claim 1 in which the body comprises an unattached portion thereof that is engageable with said at least one second portion of the perimeter area when the attached portion of the body is attached to said at least one first portion of the perimeter area.

4. A drain cover assembly according to claim 3 in which the unattached portion of the body is movable relative to the frame between a closed position, in which an engagement region of the unattached portion is engaged with at least part of said at least one second portion of the perimeter area, and an open position, in which the unattached portion of the body is at least partially disengaged with said at least one second portion of the perimeter area.

5. A drain cover assembly according to claim 4 in which the unattached portion of the body is biased to the closed position.

6. A drain cover assembly according to claim 3 in which the unattached portion of the body is bendable away from the exterior portion of the frame in response to pressure exerted on the unattached portion by at least one fluid located in the drain, to at least partially disengage the unattached portion from said at least one second portion of the perimeter area, allowing said at least one fluid to flow out of the drain.

7. A drain cover assembly according to claim 1 in which:
the body comprises an inner side thereof and an opposed outer side;
in the attachment portion, the inner side is attachable to at least part of the first portion of the perimeter area; and
in the unattached portion, the inner side is engageable with said at least one second portion of the perimeter area when the attachment portion is attached to said at least one first portion.

8. A drain cover assembly according to claim 7 in which the unattached portion is movable relative to the frame between a closed position, in which an inner engagement region of the inner side in the unattached portion is engaged with at least part of said at least one second portion of the perimeter area, and an open position, in which the inner engagement region is at least partially unengaged with the second portion of the perimeter area.

9. A method of controlling a flow of at least one fluid in a drain located in a frame of an architectural element system at least partially defined by an exterior portion of the frame comprising an aperture in fluid communication with the drain, the method comprising:
(a) providing a body formed to cover the aperture and a perimeter area of the exterior portion surrounding the aperture;
(b) with an attachment element, attaching an attachment portion of the body to at least one first portion of the perimeter area; and
(c) permitting an unattached portion of the body to move between a closed position, in which an engagement region of the unattached portion of the body is substantially engaged with at least part of at least one second portion of the perimeter area that is unattached to the attachment portion, and an open position, in which the unattached portion of the body is at least partially disengaged from said at least one second portion of the perimeter area.

10. An architectural element system for installation in a structure, the architectural element system comprising:
a frame comprising an exterior portion thereof and a drain therein in fluid communication with an aperture located in the exterior portion;
a body formed to cover the aperture and a perimeter area of the exterior portion located around the aperture;
an attachment element for attaching an attachment portion of the body to at least one first portion of the perimeter area; and
the perimeter area additionally comprising at least one second portion that is unattached to the attachment portion of the body.

11. An architectural element system according to claim 10 in which said at least one first portion of the perimeter area to which the attachment portion of the body is attached is at least partially located above the aperture.

12. An architectural element system according to claim 10 in which the body comprises an unattached portion thereof that is engageable with said at least one second portion of the perimeter area when the attached portion of the body is attached to said at least one first portion of the perimeter area.

13. An architectural element system according to claim 12 in which the unattached portion of the body is movable relative to the frame between a closed position, in which an engagement region of the unattached portion is engaged with at least part of said at least one second portion of the perimeter area, and an open position, in which the unattached portion of the body is at least partially disengaged with said at least one second portion of the perimeter area.

14. An architectural element system according to claim 13 in which the unattached portion of the body is biased to the closed position.

15. An architectural element system according to claim 12 in which the unattached portion of the body is bendable away from the exterior portion of the frame in response to pressure exerted on the unattached portion by at least one fluid located in the drain, to at least partially disengage the unattached portion from said at least one second portion of the perimeter area, allowing said at least one fluid to flow out of the drain.
